(19) United States
(12) Patent Application Publication
(10) Pub. No.: US 2026/0239434 A1
(43) Pub. Date: Aug. 13, 2026

(54) DYNAMIC RANDOM ACCESS CHANNEL RESOURCES

(71) Applicant: Nokia Technologies Oy, Espoo (FI)

(72) Inventors: Juha Sakari KORHONEN, Espoo (FI); Luis Guilherme UZEDA GARCIA, Massy (FR); Zexian LI, Espoo (FI); Frank FREDERIKSEN, Aalborg (DK); Navin HATHIRAMANI, Dallas, TX (US)

(21) Appl. No.: 19/153,504

(22) PCT Filed: Feb. 9, 2023
(86) PCT No.: PCT/US2023/012725

§ 371 Date: Aug. 4, 2025

(51) Int. Cl. H04W 74/0833

(52) U.S. Cl. CPC H04W 74/0833

(57) ABSTRACT

Dynamic random access channel resource allocation is provided. A method for dynamic random access channel resource allocation may include receiving (610) a configuration from a network entity of at least one of a plurality of semi-static and dynamic physical random access channel resources for network access. The plurality of semi-static physical random access channel resources are available without separate activation and the plurality of dynamic physical random access channel resources are available with separate activation. The method may also include determining (620) an availability of at least one of the plurality of dynamic physical random access channel resources, and selecting (630) at least one resource for preamble transmission from the at least one dynamic physical random access channel resource or from a combined set of semi-static and dynamic physical random access 620 channel resources, when the at least one dynamic physical random access channel resource is determined to be available.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to dynamic random-access channel (RACH) resources.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions. The instructions, when executed by the at least one processor, may cause the apparatus at least to receive a configuration from a network entity of at least one of a plurality of semi-static and dynamic physical random access channel resources for network access. The plurality of semi-static physical random access channel resources may be available without separate activation and the plurality of dynamic physical random access channel resources are available with separate activation. The apparatus may also be caused to determine an availability of at least one of the plurality of dynamic physical random access channel resources, and when the at least one dynamic physical random access channel resource is determined to be available, select at least one resource for preamble transmission from the at least one dynamic physical random access channel resource or from a combined set of semi-static and dynamic physical random access channel resources.

Some exemplary embodiments may also provide an apparatus including at least one processor and at least one memory storing instructions. The instructions, when executed by the at least one processor, may cause the apparatus at least to configure and provide, to a user equipment, at least one of a plurality of semi-static and dynamic physical random access channel resources for network access. The plurality of semi-static physical random access channel resources may be available without separate activation and the plurality of dynamic physical random access channel resources are available with separate activation. The apparatus may be further caused to receive, from the user equipment, a preamble for at least one resource from the at least one dynamic physical random access channel resource or from a combined set of semi-static and dynamic physical random access channel resources.

Certain exemplary embodiments may also provide a method including receiving a configuration from a network entity of at least one of a plurality of semi-static and dynamic physical random access channel resources for network access. The plurality of semi-static physical random access channel resources may be available without separate activation and the plurality of dynamic physical random access channel resources are available with separate activation. The method may further include determining an availability of at least one of the plurality of dynamic physical random access channel resources, and when the at least one dynamic physical random access channel resource is determined to be available, selecting at least one resource for preamble transmission from the at least one dynamic physical random access channel resource or from a combined set of semi-static and dynamic physical random access channel resources.

Various exemplary embodiments may provide a method including configuring and providing, to a user equipment, at least one of a plurality of semi-static and dynamic physical random access channel resources for network access. The plurality of semi-static physical random access channel resources may be available without separate activation and the plurality of dynamic physical random access channel resources are available with separate activation. The method may further include receiving, from the user equipment, a preamble for at least one resource from the at least one dynamic physical random access channel resource or from a combined set of semi-static and dynamic physical random access channel resources.

Some exemplary embodiments may provide an apparatus including means for receiving a configuration from a network entity of at least one of a plurality of semi-static and dynamic physical random access channel resources for network access. The plurality of semi-static physical random access channel resources may be available without separate activation and the plurality of dynamic physical random access channel resources are available with separate activation. The apparatus may also include means for determining an availability of at least one of the plurality of dynamic physical random access channel resources, and means for, when the at least one dynamic physical random access channel resource is determined to be available, selecting at least one resource for preamble transmission from the at least one dynamic physical random access channel resource or from a combined set of semi-static and dynamic physical random access channel resources.

Various exemplary embodiments may provide an apparatus including means for configuring and providing, to a user equipment, at least one of a plurality of semi-static and dynamic physical random access channel resources for network access. The plurality of semi-static physical random access channel resources may be available without separate activation and the plurality of dynamic physical random access channel resources are available with separate activation. The apparatus may also include means for receiving, from the user equipment, a preamble for at least one resource from the at least one dynamic physical random access channel resource or from a combined set of semi-static and dynamic physical random access channel resources.

Various exemplary embodiments may provide a non-transitory computer readable storage medium storing instruction that, when executed by at least one processor of an apparatus, may cause the apparatus at least to perform one or more of the methods herein. Further, certain exemplary embodiments may provide a computer program including instructions that, when executed by an apparatus, may cause the apparatus to perform one or more of the methods herein.

Certain exemplary embodiments may provide an apparatus including one or more circuitry configured to perform one or more of the methods herein.

### BRIEF DESCRIPTION OF THE DRAWINGS

For proper understanding of example embodiments, reference should be made to the accompanying drawings, as follows:

FIG. 1 illustrates examples of conventional two-step and four-step random access procedures;

FIG. 2 illustrates an example of a procedure for dynamic PRACH resource control, according to various exemplary embodiments;

FIG. 3 illustrates an example of a flow diagram of selecting between dynamic PRACH and semi-static PRACH, according to various exemplary embodiments;

FIG. 4 illustrates an example of a flow diagram for a UE performing random access and being configured with dynamic PRACH resources, according to various exemplary embodiments;

FIG. 5 illustrates an example of a procedure in which activation downlink control information preceding a configured dynamic PRACH resource may occur, according to some exemplary embodiments;

FIG. 6 illustrates an example of a flow diagram of a method according to various exemplary embodiments;

FIG. 7 illustrates a set of apparatuses according to various exemplary embodiments; and

FIG. 8 illustrates an example of a flow diagram of another method according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for dynamic RACH resources. Although the devices discussed below and shown in the figures refer to 5G or Next Generation NodeB (gNB) devices, this disclosure is not limited to only gNBs. For example, the following description may also apply to any type of network access node.

In an NR network, a communication connection may be initiated between devices, such as a user equipment (UE) and a network device, such as a base station, gNB, etc., through a random access (RA) procedure by employing a physical random access channel (PRACH). For example, a base station may send PRACH configuration information to the UE. The PRACH configuration information may indicate conditions to trigger selection of a two-step or a four-step RA procedure at the UE. Based on the PRACH configuration information, the UE may determine reference signal received power (RSRP) values of a synchronization signal or a reference signal received from the base station. The UE may then select the two-step RA procedure or the four-step RA procedure based on the RSRP value of the synchronization signal or the reference signal relative to the threshold.

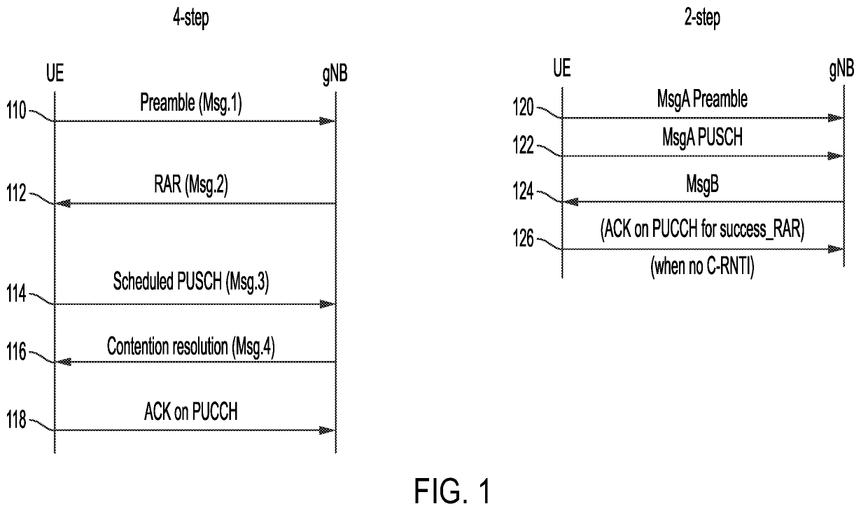

FIG. 1 illustrates examples of conventional two-step and four-step RA procedures. In order to obtain uplink (UL) synchronization or request UL radio resources, the UE may initiate the RA procedure by sending a preamble and waiting for an RA response (RAR) scheduled by Physical Downlink Control Channel (PDCCH) identified by a random access radio network temporary identifier (RA-RNTI) within a certain period of time.

In the four-step RA procedure of FIG. 1, at 110, the UE may transmit a preamble, also known as Msg1, to a network entity, also known as a gNB. At 112, the gNB may transmit an RAR to the preamble, such as Msg. 2, and at 114, the UE may transmit a scheduled physical uplink shared channel (PUSCH) to the gNB, also known as Msg. 3. At 116, the gNB may acknowledge receiving the PUSCH by transmitting a contention resolution, also known as Msg. 4, to the UE, and at 118, the UE may transmit an acknowledgement to the gNB on a physical uplink control channel (PUCCH).

In the two-step RA procedure, at 120, the UE may transmit a preamble, also known as MsgA, to the gNB, and at 122, the UE may transmit the corresponding PUSCH of the preamble to the gNB. In this example, the combines Msg. 1 and Msg. 3 of the four-step RA procedure into one message, e.g., MsgA, and transmits to the gNB. At 124, the gNB may transmit a response to the UE. In the response, the gNB may combine Msg. 2 and Msg. 4 of the four-step RACH procedure for the UE, as MsgB. At 126, the gNB sends an acknowledgement on the PUCCH for success in an RAR, when no cell RNTI (C-RNTI) is present.

The preamble response (Msg. 2) of the contention based four-step procedure acknowledges reception of the preamble, while MsgB of the two-step procedure may be directed to a single UE (i.e. resolving contention when MsgA-PUSCH is received successfully) or may be just a preamble response (fallback to the 4-step procedure when MsgA-PUSCH is not received). For addressing the response to the preamble, there is a mapping from the time and frequency resource of the preamble to an RA-RNTI in the four-step procedure and MsgB-RNTI in the two-step procedure.

When the PRACH becomes congested, such as by preamble collisions becoming too frequent, there may be multiple conventional procedures for compensating for the congestion including, for example: (1) by access barring to prevent a UE from performing random access, (2) by signaling a back-off indicator in the preamble response, so that the network may indicate a waiting time period during which UEs wait before attempting random access again after a failed preamble transmission, and/or (3) by configuring more PRACH resources. The access barring and back-off indicator may directly affect UEs by delaying or preventing the access. Configuring additional resources may allow easing of the congestion without affecting initial access latency while having less resources for other types of communication.

According to 3GPP specifications, the network may configure random access resources semi-statically using system information. When the network determines that PRACH allocation needs to be changed, such as for increasing or decreasing the PRACH capacity corresponding to the load, the network may send a paging message to the UE. The paging message may indicate that the system information will change in the beginning of the next system information block (SIB) modification period. The SIB modification period may be configured in the system information as a product of a coefficient (2 . . . 16) and the default paging cycle (32 . . . 256 radio frames). When the default paging cycle has been configured to 256 radio frames (for larger UE power saving) and have a coefficient of 2, a total of 512 radio frames may be used to define the SIB modification period. For example, the system configuration may be updated only every 5.12 seconds.

Changing the PRACH configuration may be a slow process that may include an indication of system information change to the UEs and the UEs reading the new system information. System information changes may be minimized to avoid UEs having to read the updated information more frequently. The SIB modification indication may indicate to all UEs in the cell that the configuration will change at the start of the next SIB modification period. This may cause uncertainty as to whether UEs have read the updated configuration, since at least some UEs may have coverage issues that cause the UEs to not be able to read the updated SIB information in the first SIB scheduling window.

According to various exemplary embodiments, it may be advantageous to provide a more flexible and faster procedure for UEs to learn about changes in the PRACH configuration. For example, certain exemplary embodiments may provide the flexibility to have a system where subset UE group(s) may follow changes in the PRACH resource allocation.

Various exemplary embodiments may provide at least two types of PRACH resources including, for example: (1) semi-statically configured resources that are available without separate activation, and (2) dynamic resources that become available only when they are activated. Activation may be signalled with group common downlink control information (GC-DCI) or medium access control (MAC) signaling. The activation may be valid for a validity time period according to a semi-static configuration or as indicated with activation signaling.

According to certain exemplary embodiments, it may be advantageous to provide activation signaling that indicates a service or a use case or UE capability that the activation of dynamic resources applies to. The indication may be direct or indirect. In indirect indication, each service/use capability may be mapped to a partition of semi-statically configured resources and the activation signal indicates the partition of semi-static resources targeted with the activation. For example, activation may indicate which resource partition is expanded or replaced with additional resources. An activation time window may be defined. UEs may need to search activation indication for a limited time within a longer period. The activation time window may be determined based on the RAR time window.

According to some exemplary embodiments, it may be advantageous to provide MAC based activation signaling that may be included in the RAR as a new MAC control element (MAC-CE) or sub-header. Further, activation of a dynamic PRACH resource may use an existing back-off indicator value, which is a back-off indicator larger than a configured value means that dynamic RACH resources are available. This may limit the use of dynamic resources to situations with RACH congestion while saving from specifying new L1 or MAC signaling. Further, switching between semi-static and dynamic resources within a random-access procedure may occur according to the validity of the activation or configured rules.

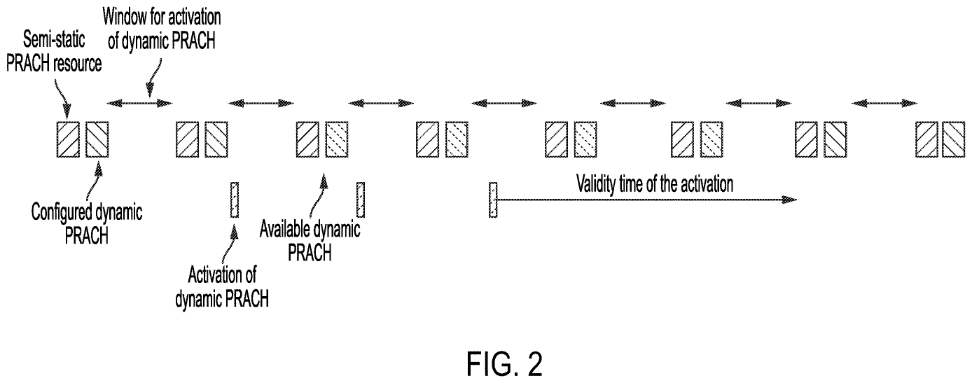

FIG. 2 illustrates an example of a procedure for dynamic PRACH resource control, according to various exemplary embodiments. The network may configure semi-static PRACH resources, which are available when configured by system information. In addition, there may be PRACH resources that need to be activated dynamically before they become available, which may be determined in multiple ways.

As a first example for determining the dynamic resources, one or more dynamic PRACH resource may be configured semi-statically by system information so that no PRACH configuration parameters are needed in the activation signal. When more than one dynamic PRACH resource is configured, an index or indexes of activated configurations may be included in the activation message.

As a second example for determining the dynamic resources, the system information may include a one-bit indication that the network supports operation with dynamic PRACH resources. The parameters for determining the dynamic resources may be included in the activation signaling. A full PRACH configuration may not be necessary for dynamic resources. For example, a frequency or time offset with respect to the semi-static PRACH resources may be sufficient.

As a third example for determining the dynamic resources, some resource parameters may be provided semi-statically and other resource parameters by dynamic signaling with activation.

The exemplary embodiments are not limited to only these examples, and may include additional procedures for determining the dynamic resources and/or any combination of procedures for determining the dynamic resources.

The activation may be relevant for particular UEs. The relevant UEs may be users to which improved or increased service may be provided by activating dynamic PRACH resources for the relevant UEs. The relevant UEs may also be of relative lower priority, and the RACH load from the lower priority UEs may be moved to the dynamic resources to allow improved or increased service on semi-statically configured resources for the remainder of the UEs.

There could be multiple services/use case/capabilities defined for dynamic activation and different procedures of indicating which service/use case/capabilities that the dynamic activation applies to. As an example, the activation signaling may directly indicate the index of the service/use case/capability. As another example, a service/use case/capability may be mapped to a set of preamble identifiers (IDs) and the activation signaling may indicate a mapping from a preamble ID set to a dynamic PRACH resource. As yet another example, a dynamic PRACH resource may be configured for a service/use case/capability and associated to an indication carried by activation signaling, For instance, a service 1 and 2 may be configured with dynamic resource 1 and 2, respectively, and activation signaling includes a first bit associated to service 1 and the second bit associated to service 2, such that signaling bit string [1 0] activates resources only for service 1, [0 1] activates resources for service 2, and [1 1] activates resources for both services. In a case where before activation, X preamble IDs are available for a certain use, then after the activation, X+64 IDs may be available. For example, after activation, X preamble IDs on the semi-static and 64 preamble IDs on the dynamic resources. A determination of the preamble ID may be split for different uses in the dynamic RACH resources that may be dependent on semi-static RACH configuration of IDs for different services/use case/capabilities and the activation signal.

The dynamic activation may occur through GC-DCI or MAC signaling. For the DCI signaling based approach, system information configuration of the dynamic resources may include an RNTI for addressing activation DCIs. For a MAC signaling based approach, a resource activation MAC subheader or MAC CE may be defined that may be sent attached to the RAR message. The RAR message may contain the activation subheader or, in addition, responses to the detected preambles.

When existing back-off (BO) signaling is utilized for activation, there may be multiple BO thresholds for activation. The activated dynamic resource(s) may depend on the severity of the overload, such as the larger the indicated BO, the larger the dynamically activated resource. In addition, the BO threshold may depend on the use case, such as when higher priority may correspond to a smaller BO threshold for activation.

An activation time window may be defined. The UE, which is eligible for using the dynamic resources, may need to search activation indication for a limited time within a longer time period. The activation time window may be determined by the UE based on the RAR time window. With DCI based activation signaling, the activation time window may be equal to, or a fraction of, the RAR time window corresponding to the smallest RA-RNTI (or MsgB-RNTI in the two-step procedure) reserved for the semi-statically configured RACH resources. When the UE does not find an activation DCI in the RAR time window, the UE may assume the dynamic resources are not active, unless the validity time of a previously detected activation has not yet expired. The activation and RAR time window may have a common starting time, but the length of the activation window may be a fraction of the length of the RAR time window in order to minimize the UE's efforts for detecting activation. As an example, the RAR window may be equal to or less than 10 ms.

With MAC based signaling, the activation may be sent in an RAR message addressed with, for example, the smallest RA-RNTI/MsgB-RNTI of the dynamic RACH resources. For example, RA-RNTIs/MsgB-RNTIs for the dynamic PRACH may be derived similarly for the semi-static PRACH resources. When the UE receives the RAR addressed with the smallest RA-RNTI/MsgB-RNTI and without an activation MAC sub-header or MAC CE, the UE may assume that the dynamic resources are not available, unless the validity time of a previously detected activation has not yet expired. An indication through the RAR of dynamic RACH resources, instead of semi-static resources, may be advantageous because UEs would not need to decode RAR messages if the dynamic resources are not active. The UEs may instead search for DCI of the RAR PDSCH.

A validity time of the activation may also be defined. Once the UE has received an activation message, the UE may assume that the dynamic resources are available at least for the validity time. The validity time may be from the end of a slot where the activation message is received until a certain number of slots has elapsed from the end of the time window of activation where the activation message was received. After the UE has received the activation message, the UE may use the dynamic resources during the validity time without searching for the activation message again. The UE may be allowed to start random access using the semi-static PRACH resources and may switch to dynamic resources for preamble retransmission if activation is detected. When the activation validity expires after preamble transmission on dynamic resources, the UE may switch to semi-static resources for preamble retransmission. In certain exemplary embodiments, the parameter defining the activation validity time (e.g., number of slots) may be hard-coded in the specification, or semi-statically configured through system information, or included in DCI or MAC signaling by indicating flexibly one of a few configured values.

In some exemplary embodiments, when random access is needed, a UE, eligible or obliged for utilizing the dynamic resources, may operate in different circumstances. As a first example, the UE may have detected an activation indication in the past and the validity time of the activation will not expire before the next dynamic PRACH resource. In this case, the UE may use the next dynamic PRACH resource. After sending the preamble, the UE may search for an activation indication while attempting to receive a preamble response. If the activation indication is received/determined, the UE may restart the timer for the activation validity.

As another example, the UE may not know if the dynamic resources are active. If the UE is instructed/required to use dynamic resources when they are active, the UE searches the activation signal from the next activation time window. When the UE does not detect activation, the UE may use the semi-static resources for the RA attempt. When the UE is eligible to use dynamic resources but not instructed/required to use dynamic resources, the UE may choose between using the semi-static resources or postponing an RA attempt for detecting if dynamic resources are active. If the UE chooses to attempt RA through semi-static resources and fails in the attempt, then the UE may switch to dynamic resources as soon as the UE detects that the dynamic resources are available. The detection of the availability of the dynamic resources may occur at least partially concurrently or in parallel with searching for a response to the preamble sent on the semi-static resources.

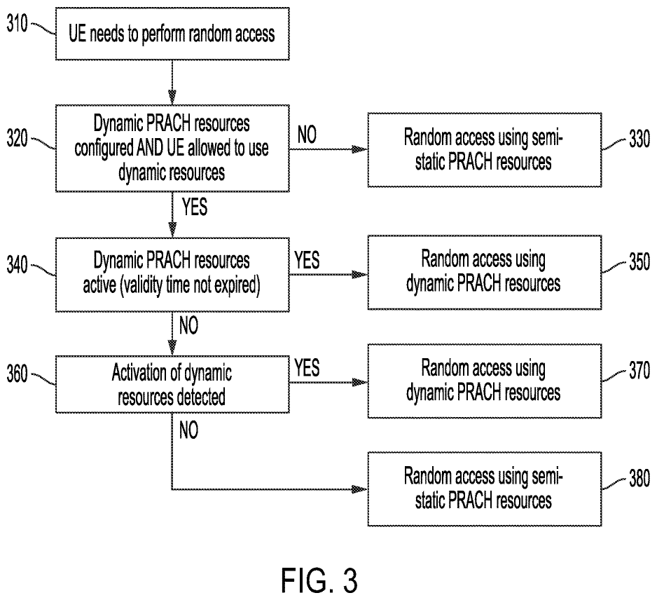

FIG. 3 illustrates an example of a flow diagram of a procedure in which a UE similar to apparatus 710 may select between dynamic PRACH and semi-static PRACH, according to various exemplary embodiments. In the example of FIG. 3, a UE may be either required to or chooses to check for an activation message when no valid activation exists at the beginning of the procedure.

As shown in FIG. 3, at 310, a UE may determine to perform RA, and at 320, the UE may determine whether dynamic PRACH resources are configured and whether the UE is allowed to use the configured dynamic resources. When the dynamic PRACH resources are not configured and/or the UE is not allowed to use the configured dynamic resources (“NO” decision at 320), then the procedure may proceed to 330. At 330, the UE may perform RA using semi-static PRACH resources. When the dynamic PRACH resources are configured and the UE is allowed to use the configured dynamic resources (“YES” decision at 320), the procedure may proceed to 340.

At 340, the UE may determine whether the dynamic PRACH resources are active. When the dynamic PRACH resources are active, i.e., the UE has received activation signaling and the validity timer has not expired (“YES” decision at 340), the procedure may proceed to 350 where RA may be performed using the dynamic PRACH resources. When the dynamic PRACH resources are not active, i.e., the resources have not been activated or validity time has expired after activation (“NO” decision at 340), the procedure may proceed to 360. At 360, the UE may determine/detect whether activation of the dynamic resources has occurred during the UE preparation time for preamble transmission. When activation of the dynamic resources has occurred (“YES” decision at 360), the procedure may proceed to 370 where RA may be performed using the dynamic PRACH resources. When activation of the dynamic resources has not occurred (“NO” decision at 360), the procedure may proceed to 380 where RA may be performed using semi-static PRACH resources.

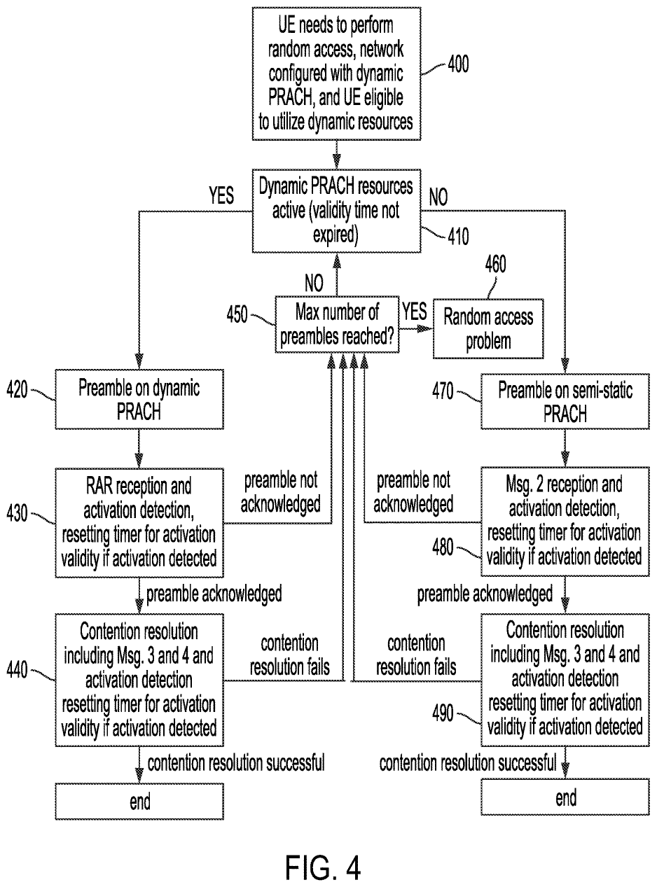

FIG. 4 illustrates an example of a flow diagram of a procedure in which a UE similar to apparatus 710 may attempt RA using semi-static PRACH or dynamic PRACH, according to various exemplary embodiments. If dynamic resources are detected to be active, the UE may switch to using the dynamic resources when the UE fails to receive a response to a preamble sent on semi-static resources or the contention resolution fails or the UE receives an indication of active dynamic PRACH resources.

In the example of FIG. 4, at 400, the UE may determine, or may be instructed, to perform RA. The network may be configured with dynamic PRACH resources, and the UE may be eligible to use the dynamic PRACH resources. At 410, the UE determines whether the dynamic PRACH resources are active. When the dynamic PRACH resources are active, i.e., the UE has received activation signaling and the validity timer has not expired (“YES” decision at 410), the procedure continues to 420-440, and when the dynamic PRACH resources are not active (“NO” decision at 410), the procedure continues to 470-490, as discussed in detail hereinafter.

At 420, when the dynamic PRACH resources are active, the preamble for the dynamic PRACH resources may be used/set and transmitted to a network entity for RA, and at 430, RAR reception and activation may be detected. The validity timer for activation validity may be reset if activation is detected. The UE may determine, as part of RAR reception, if the preamble has been acknowledged. When the preamble has not been acknowledged, the procedure may proceed to 450. At 450, the UE may determine whether a maximum number of preambles has been reached. When the maximum number of preambles has not been reached (“NO” decision at 450), the procedure may return to 410 to continue. When the maximum number of preambles has been reached (“YES” decision at 450), the procedure may continue to 460, where it may be determined that an RA problem exists, and the procedure may be terminated.

When it is determined that the preamble has been acknowledged at 430, the procedure may continue to 440. At 440, contention resolution may be determined in which Msg. 3 and Msg. 4 may be included. Further, the UE may detect whether activation has occurred for resetting the timer for activation validity when the activation is detected. When contention resolution is determined to fail, the procedure may return to 450, and when contention resolution is determined to be successful, the procedure may continue to complete RA successfully.

When the dynamic PRACH resources are not active (“NO” decision at 410), the procedure may continue to 470-490. At 470, the preamble for semi-static PRACH resources may be used/set and transmitted to the network entity for RA. At 480, the UE may determine whether Msg. 2 reception and activation have occurred. When activation is detected, the UE may reset the timer for activation validity. The UE also may determine from the Msg. 2 reception whether the preamble has been acknowledged. When the preamble has not been acknowledged, the procedure may proceed to 450. When the preamble has been acknowledged, the procedure may continue to 490. At 490, contention resolution may be determined in which Msg. 3 and Msg. 4 may be included. Further, the UE may detect whether activation has occurred for resetting the timer for activation validity when the activation is detected. When contention resolution is determined to fail, the procedure may return to 450, and when contention resolution is determined to be successful, the procedure may continue to complete RA successfully.

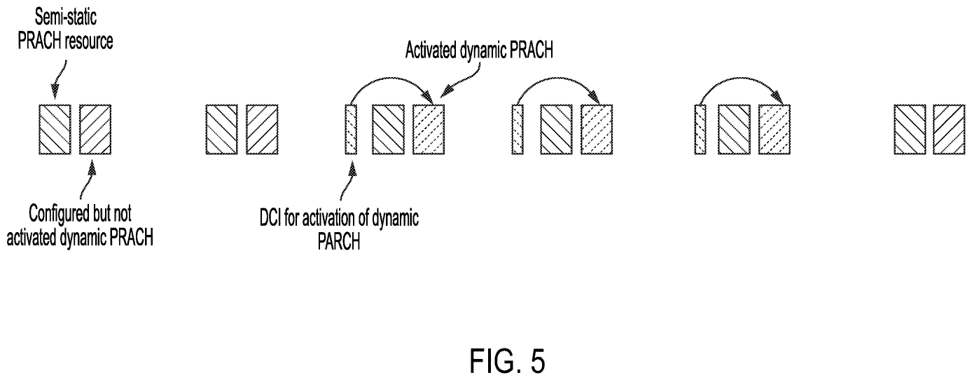

FIG. 5 illustrates an example of a procedure in which activation DCI preceding a configured dynamic PRACH resource may occur, according to some exemplary embodiments. In FIG. 5, a base station, such as a gNB, may potentially send a DL control message prior to each semi-statically configured PRACH resource. For example, this DL control message may be denoted a RACH Occasion (RO). A UE may proactively monitor for the DL control message, and when the base station signals “activate”, the UE may be allowed to use additional resources as part of a pool of resources to consider for the RA procedure. The base station may thus have the option of adjusting the PRACH capacity in a dynamic manner, while the UE may have the flexibility of having significantly increased probability of avoiding collision (lower delay) for a RACH occasion at the cost of slightly higher power consumption, due to the reading of the DL control message. The DL control message may be implemented as either a DCI using group based signaling (G-RNTI based DCI) or broadcast indication, which may associate the broadcast information with a specific RNTI to use for the monitoring.

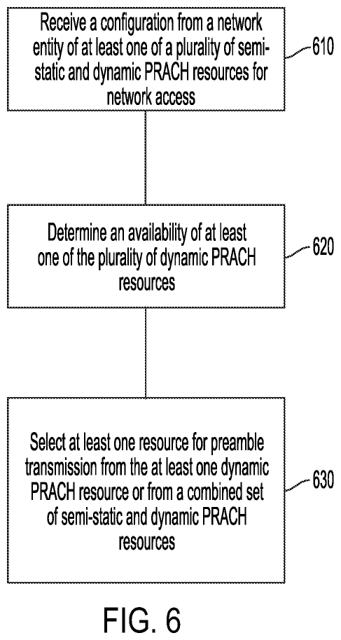

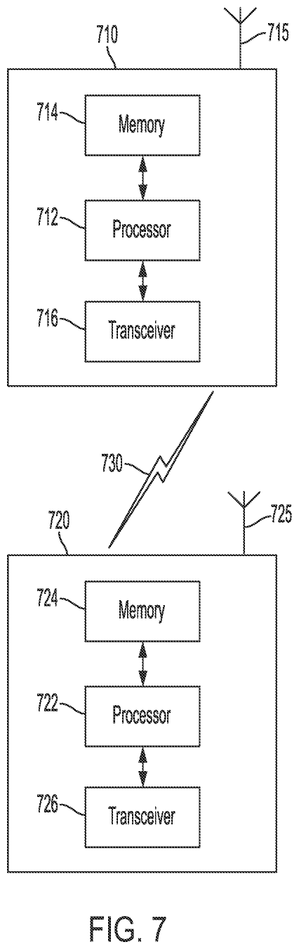

FIG. 6 illustrates an example flow diagram of a method, according to certain exemplary embodiments. In an example embodiment, the method of FIG. 6 may be performed by a network element, or a group of multiple network elements in a 3GPP system, such as LTE or 5G-NR. For instance, in an exemplary embodiment, the method of FIG. 6 may be performed by a device, such as a UE, similar to apparatus 710 illustrated in FIG. 7.

According to various exemplary embodiments, the method of FIG. 6 may include, at 610, receiving a configuration, from a network entity similar to apparatus 720, of at least one of a plurality of semi-static and dynamic PRACH resources for network access. The plurality of semi-static PRACH resources are available without separate activation and the plurality of dynamic PRACH resources are available with separate activation.

At 620, the method may further include determining an availability of at least one of the plurality of dynamic PRACH resources. The method may also include, at 630, selecting at least one resource for preamble transmission from the at least one dynamic PRACH resource or from a combined set of semi-static and dynamic PRACH resources, when the at least one dynamic PRACH resource is determined to be available.

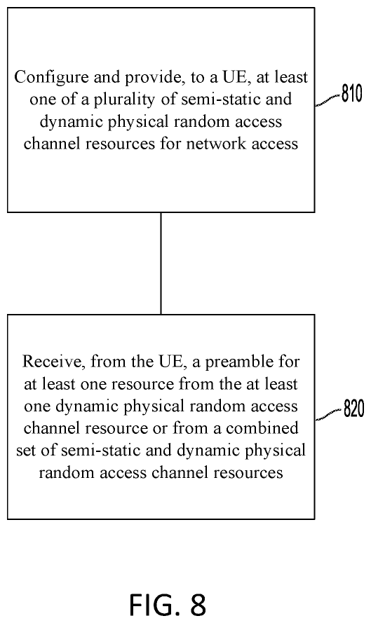

FIG. 8 illustrates an example flow diagram of a method, according to certain exemplary embodiments. In an example embodiment, the method of FIG. 8 may be performed by a network element, or a group of multiple network elements in a 3GPP system, such as LTE or 5G-NR. For instance, in an exemplary embodiment, the method of FIG. 8 may be performed by a network device similar to apparatus 720 illustrated in FIG. 7.

According to various exemplary embodiments, the method of FIG. 8 may include, at 810, configuring and providing, to a UE similar to apparatus 710, at least one of a plurality of semi-static and dynamic physical random access channel resources for network access. The plurality of semi-static physical random access channel resources may be available without separate activation and the plurality of dynamic physical random access channel resources are available with separate activation. The method may further include, at 820, receiving, from the UE, a preamble for at least one resource from the at least one dynamic physical random access channel resource or from a combined set of semi-static and dynamic physical random access channel resources.

FIG. 7 illustrates a set of apparatuses 710 and 720 according to various exemplary embodiments. In the various exemplary embodiments, the apparatus 710 may be may be an element in a communications network or associated with such a network, such as a UE, RedCap UE, SL UE, mobile equipment (ME), mobile station, mobile device, stationary device, IoT device, or other device. For example, the UEs according to various exemplary embodiments as discussed above may be examples of apparatus 710. It should be noted that one of ordinary skill in the art would understand that apparatus 710 may include components or features not shown in FIG. 7. In addition, apparatus 720 may be a network, network entity, element of the core network, or element in a communications network or associated with such a network, such as a base station, an NE, or a gNB. For example, the network and the gNB according to various exemplary embodiments discussed above may be examples of apparatus 720. It should be noted that one of ordinary skill in the art would understand that apparatus 720 may include components or features not shown in FIG. 7.

According to various exemplary embodiments, the apparatus 710 may include at least one processor 712, and at least one memory 714, as shown in FIG. 7. The memory 714 may store instructions that, when executed by the processor 712, may cause the apparatus 710 to receive a configuration, from a network entity similar to apparatus 720, of at least one of a plurality of semi-static and dynamic PRACH resources for network access. The plurality of semi-static PRACH resources are available without separate activation and the plurality of dynamic PRACH resources are available with separate activation. The apparatus may further be caused to determine an availability of at least one of the plurality of dynamic PRACH resources, and select at least one resource for preamble transmission from the at least one dynamic PRACH resource or from a combined set of semi-static and dynamic PRACH resources, when the at least one dynamic PRACH resource is determined to be available.

In some exemplary embodiments, a dynamic resource may be determined available when an activation message activating the at least one dynamic physical random access channel resource is received or when the apparatus determines that an earlier received activation is still valid. Further, the activation message may be configured to indicate a restriction of the activation to apply for a service or a use case in which the random access is initiated or to apply for an indicated capability or set of capabilities of the apparatus.

According to certain exemplary embodiments, the configuration of the at least one of the plurality of dynamic physical random access channel resources may be received in system information or at least partly through the activation message.

According to various exemplary embodiments, the activation message may be monitored in a monitoring time window defined relative to either a start of a random access occasion or a start of a random access response window. Further, the activation may apply for a specific random access occasion or for multiple random access occasions within a validity time period that is specified, configured by system information, indicated in the activation message, or for a next upcoming monitoring time window.

In some exemplary embodiments, a new validity time period may start when the activation message is received, and the start of the validity time period may be relative to the monitoring time window of the activation message.

According to various exemplary embodiments, the availability of the at least one of the plurality of dynamic physical random access channel resources may be determined for each preamble transmission during a random access procedure. Further, when the availability of the at least one of the plurality of dynamic physical random access channel resources changes within a procedure, the apparatus 710 may be further caused to switch between using dynamic and semi-static dynamic physical random access channel resources according to the availability.

In certain exemplary embodiments, the activation message is attached to a random access response message. Further, the at least one dynamic physical random access channel resource may be activated when a value of a back-off indicator in a random access response message exceeds a configured threshold.

According to various exemplary embodiments, the apparatus 720 may include at least one processor 722, and at least one memory 724, as shown in FIG. 7. The memory 724 may store instructions that, when executed by the processor 722, may cause the apparatus 720 to configure and provide, to a UE similar to apparatus 710, at least one of a plurality of semi-static and dynamic physical random access channel resources for network access, wherein the plurality of semi-static physical random access channel resources are available without separate activation and the plurality of dynamic physical random access channel resources are available with separate activation. The apparatus 720 may be further caused to receive, from the UE, a preamble for at least one resource from the at least one dynamic physical random access channel resource or from a combined set of semi-static and dynamic physical random access channel resources.

According to various exemplary embodiments, the apparatus 720 may be further caused to provide an activation message configured to indicate a restriction of the activation to apply for a service or a use case in which the random access is initiated or to apply for an indicated capability or set of capabilities of the apparatus 720. Further, the configuration of the at least one of the plurality of dynamic physical random access channel resources may be sent in system information or at least partly through the activation message.

In some exemplary embodiments, the activation message may be sent in a monitoring time window defined relative to either a start of a random access occasion or a start of a random access response window. Further, the activation may apply for a specific random access occasion or for multiple random access occasions within a validity time period that is specified, configured by system information, indicated in the activation message, or for a next upcoming monitoring time window.

In various exemplary embodiments, a new validity time period may start when the activation message is sent, and the start of the validity time period may be relative to the monitoring time window of the activation message.

According to certain exemplary embodiments, the activation message may be attached to a random access response message. Further, the at least one dynamic physical random access channel resource may be activated when a value of a back-off indicator in a random access response message exceeds a configured threshold.

Various exemplary embodiments described above may provide several technical improvements, enhancements, and/or advantages. For instance, some exemplary embodiments may provide advantages in which activating dynamic RACH resources may (i) minimize a UE's efforts and processing power for searching for the activation signal as an activation time window is defined, (ii) allow for combining the activation signaling to RAR messages, which minimizes the resource use, (iii) provide flexibility to activate a dynamic resource for a service/use capability, (iv) provide procedures that reduce the complexity, and thus processing power, of specifying and providing efficient signaling when services/use capabilities are mapped to different partitions of semi-static resources, (v) minimize specification effort by utilizing existing back-off signaling for activation, and (vi) define switching between dynamic and semi-static resource use within an RA procedure to minimize latency.

In some example embodiments, apparatuses 710 and/or 720 may include one or more processors, one or more computer-readable storage medium (for example, memory, storage, or the like), one or more radio access components (for example, a modem, a transceiver, or the like), and/or a user interface. In some example embodiments, apparatuses 710 and/or 720 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 7, apparatuses 710 and/or 720 may include or be coupled to processors 712 and 722, respectively, for processing information and executing instructions or operations. Processors 712 and 722 may be any type of general or specific purpose processor. In fact, processors 712 and 722 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 712 (and 722) for each of apparatuses 710 and/or 720 is shown in FIG. 7, multiple processors may be utilized according to other example embodiments. For example, it should be understood that, in certain example embodiments, apparatuses 710 and/or 720 may include two or more processors that may form a multiprocessor system (for example, in this case processors 712 and 722 may represent a multiprocessor) that may support multiprocessing. According to certain example embodiments, the multiprocessor system may be tightly coupled or loosely coupled to, for example, form a computer cluster).

Processors 712 and 722 may perform functions associated with the operation of apparatuses 710 and/or 720, respectively, including, as some examples, precoding of antenna gain/phase parameters, encoding and decoding of individual bits forming a communication message, formatting of information, and overall control of the apparatuses 710 and/or 720, including processes illustrated in FIGS. 2-6.

Apparatuses 710 and/or 720 may further include or be coupled to memory 714 and/or 724 (internal or external), respectively, which may be coupled to processors 712 and 722, respectively, for storing information and instructions that may be executed by processors 712 and 722. Memory 714 (and memory 724) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 714 (and memory 724) can be comprised of any combination of random access memory (RAM), read only memory (ROM), static storage such as a magnetic or optical disk, hard disk drive (HDD), or any other type of non-transitory machine or computer readable media. The instructions stored in memory 714 and memory 724 may include program instructions or computer program code that, when executed by processors 712 and 722, enable the apparatuses 710 and/or 720 to perform tasks as described herein.

In certain example embodiments, apparatuses 710 and/or 720 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 712 and 722 and/or apparatuses 710 and/or 720 to perform any of the methods illustrated in FIGS. 2-6.

In some exemplary embodiments, apparatus 710 may also include or be coupled to one or more antennas 715 for receiving a downlink signal and for transmitting via an uplink from apparatus 710. Apparatuses 710 and/or 720 may further include transceivers 716 and 726, respectively, configured to transmit and receive information. The transceiver 716 and 726 may also include a radio interface that may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 716 and 726 may be respectively configured to modulate information on to a carrier waveform for transmission, and demodulate received information for further processing by other elements of apparatuses 710 and/or 720. In other example embodiments, transceivers 716 and 726 may be capable of transmitting and receiving signals or data directly. Additionally or alternatively, in some example embodiments, apparatuses 710 and/or 720 may include an input and/or output device (I/O device). In certain example embodiments, apparatuses 710 and/or 720 may further include a user interface, such as a graphical user interface or touchscreen.

In certain example embodiments, memory 714 and memory 724 store software modules that provide functionality when executed by processors 712 and 722, respectively. The modules may include, for example, an operating system that provides operating system functionality for apparatuses 710 and/or 720. The memory may also store one or more functional modules, such as an application or program, to provide additional functionality for apparatuses 710 and/or 720. The components of apparatuses 710 and/or 720 may be implemented in hardware, or as any suitable combination of hardware and software. According to certain example embodiments, apparatus 710 may optionally be configured to communicate with apparatus 720 via a wireless or wired communications link 730 according to any radio access technology, such as NR.

In some exemplary embodiments, an apparatus (e.g., apparatus 710 and/or apparatus 720) may include means for performing a method, a process, or any of the variants discussed herein. Examples of the means may include one or more processors, memory, controllers, transmitters, receivers, and/or computer program code for causing the performance of the operations.

Certain exemplary embodiments may be directed to an apparatus that includes means for receiving a configuration from a network entity of at least one of a plurality of semi-static and dynamic physical random access channel resources for network access. The plurality of semi-static physical random access channel resources may be available without separate activation and the plurality of dynamic physical random access channel resources are available with separate activation. The apparatus may also include means for determining an availability of at least one of the plurality of dynamic physical random access channel resources, and/or means for selecting at least one resource for preamble transmission from the at least one dynamic physical random access channel resource or from a combined set of semi-static and dynamic physical random access channel resources, when the at least one dynamic physical random access channel resource is determined to be available.

Various exemplary embodiments may be directed to an apparatus that includes means for configuring and providing, to a UE, at least one of a plurality of semi-static and dynamic physical random access channel resources for network access. The plurality of semi-static physical random access channel resources may be available without separate activation and the plurality of dynamic physical random access channel resources are available with separate activation. The apparatus may also include means for receiving, from the UE, a preamble for at least one resource from the at least one dynamic physical random access channel resource or from a combined set of semi-static and dynamic physical random access channel resources.

According to certain example embodiments, processors 712 and 722, and memory 714 and 724 may be included in or may form a part of processing circuitry or control circuitry. In addition, in some example embodiments, transceivers 716 and 726 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 710 and/or 720) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 710 and/or 720), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:

| | |
|---|---|
| 3GPP | 3rd Generation Partnership Project |
| 5G | 5th Generation |
| 5GCN | 5G Core Network |
| 5GS | 5G System |
| ACK | Acknowledgement |
| BO | Back-Off |
| CE | Control Element |
| DCI | Downlink Control Information |
| DL | Downlink |
| EMBB | Enhanced Mobile Broadband |
| GC | Group Common |
| gNB | 5G or Next Generation NodeB |
| L1 | Layer 1 - Physical Layer |
| LTE | Long Term Evolution |
| MAC | Medium Access Control |
| Msg | Message |
| MTC | Machine Type Communications |
| NR | New Radio |
| PDCCH | Physical Downlink Control Channel |
| PDSCH | Physical Downlink Shared Channel |
| PRACH | Physical Random Access Channel |
| PUCCH | Physical Uplink Control Channel |
| PUSCH | Physical Uplink Shared Channel |
| RA | Random Access |
| RAN | Radio Access Network |
| RAR | Random Access Response |
| RACH | Random Access Channel |
| RedCap | Reduced Capability |
| RNTI | Radio Network Temporary Identity |
| RO | RACH Occasion |
| RRC | Radio Resource Control |
| UE | User Equipment |
| UL | Uplink |
| URLLC | Ultra Reliable Low Latency Communication |

1-54. (canceled)

55. An apparatus comprising:
at least one processor; and
at least one memory storing instructions that, when executed by the at least one processor, cause the apparatus at least to:
receive a configuration from a network entity of at least one of a plurality of semi-static and dynamic physical random access channel resources for network access, wherein the plurality of semi-static physical random access channel resources are available without separate activation and the plurality of dynamic physical random access channel resources are available with separate activation;
determine an availability of at least one of the plurality of dynamic physical random access channel resources; and
when the at least one dynamic physical random access channel resource is determined to be available, select at least one resource for preamble transmission from the at least one dynamic physical random access channel resource or from a combined set of semi-static and dynamic physical random access channel resources.

56. The apparatus of claim 55, wherein a dynamic resource is determined available when an activation message activating the at least one dynamic physical random access channel resource is received or when the apparatus determines that an earlier received activation is still valid.

57. The apparatus of claim 55, wherein a dynamic resource is determined available when an activation message activating the at least one dynamic physical random access channel resource is received or when the apparatus determines that an earlier received activation is still valid and wherein the activation message is configured to indicate a restriction of the activation to apply for a service or a use case in which the random access is initiated or to apply for an indicated capability or set of capabilities of the apparatus.

58. The apparatus of claim 55, wherein the configuration of the at least one of the plurality of dynamic physical random access channel resources is received in system information or at least partly through the activation message.

59. The apparatus according to claim 55, wherein:
the activation message is monitored in a monitoring time window defined relative to either a start of a random access occasion or a start of a random access response window, and
the activation applies for a specific random access occasion or for multiple random access occasions within a validity time period that is specified, configured by system information, indicated in the activation message, or for a next upcoming monitoring time window.

60. The apparatus of claim 55, wherein:
the activation message is monitored in a monitoring time window defined relative to either a start of a random access occasion or a start of a random access response window, and
the activation applies for a specific random access occasion or for multiple random access occasions within a validity time period that is specified, configured by system information, indicated in the activation message, or for a next upcoming monitoring time window and wherein a new validity time period starts when the activation message is received, and the start of the validity time period is relative to the monitoring time window of the activation message.

61. The apparatus of claim 55, wherein:
the availability of the at least one of the plurality of dynamic physical random access channel resources is determined for each preamble transmission during a random access procedure; and
when the availability of the at least one of the plurality of dynamic physical random access channel resources changes within a procedure, the apparatus is further caused to switch between using dynamic and semi-static dynamic physical random access channel resources according to the availability.

62. The apparatus of claim 55, wherein the at least one dynamic physical random access channel resource is activated when a value of a back-off indicator in a random access response message exceeds a configured threshold.

63. An apparatus comprising:
at least one processor; and
at least one memory storing instructions that, when executed by the at least one processor, cause the apparatus at least to:
configure and provide, to a user equipment, at least one of a plurality of semi-static and dynamic physical random access channel resources for network access, wherein the plurality of semi-static physical random access channel resources are available without separate activation and the plurality of dynamic physical random access channel resources are available with separate activation; and
receive, from the user equipment, a preamble for at least one resource from the at least one dynamic physical random access channel resource or from a combined set of semi-static and dynamic physical random access channel resources.

64. The apparatus of claim 63, wherein the apparatus is further caused to provide an activation message configured to indicate a restriction of the activation to apply for a service or a use case in which the random access is initiated or to apply for an indicated capability or set of capabilities of the apparatus.

65. The apparatus according to claim 64, wherein the apparatus is further caused to provide an activation message configured to indicate a restriction of the activation to apply for a service or a use case in which the random access is initiated or to apply for an indicated capability or set of capabilities of the apparatus and wherein:
the activation message is sent in a monitoring time window defined relative to either a start of a random access occasion or a start of a random access response window, and
the activation applies for a specific random access occasion or for multiple random access occasions within a validity time period that is specified, configured by system information, indicated in the activation message, or for a next upcoming monitoring time window.

66. The apparatus of claim 63, wherein the at least one dynamic physical random access channel resource is activated when a value of a back-off indicator in a random access response message exceeds a configured threshold.

67. A method, comprising:
receiving a configuration from a network entity of at least one of a plurality of semi-static and dynamic physical random access channel resources for network access, wherein the plurality of semi-static physical random access channel resources are available without separate activation and the plurality of dynamic physical random access channel resources are available with separate activation;
determining an availability of at least one of the plurality of dynamic physical random access channel resources; and
when the at least one dynamic physical random access channel resource is determined to be available, selecting at least one resource for preamble transmission from the at least one dynamic physical random access channel resource or from a combined set of semi-static and dynamic physical random access channel resources.

68. The method of claim 67, wherein a dynamic resource is determined available when an activation message activating the at least one dynamic physical random access channel resource is received or when the apparatus determines that an earlier received activation is still valid.

69. The method of claim 67, wherein the configuration of the at least one of the plurality of dynamic physical random access channel resources is received in system information or at least partly through the activation message.

70. The method according to claim 67, wherein:
the activation message is monitored in a monitoring time window defined relative to either a start of a random access occasion or a start of a random access response window, and
the activation applies for a specific random access occasion or for multiple random access occasions within a validity time period that is specified, configured by system information, indicated in the activation message, or for a next upcoming monitoring time window.

71. The method of claim 67, wherein:
the availability of the at least one of the plurality of dynamic physical random access channel resources is determined for each preamble transmission during a random access procedure; and
when the availability of the at least one of the plurality of dynamic physical random access channel resources changes within a procedure, the method further comprises switching between using dynamic and semi-static dynamic physical random access channel resources according to the availability.

72. The method of claim 67, wherein the at least one dynamic physical random access channel resource is activated when a value of a back-off indicator in a random access response message exceeds a configured threshold.
